(19) United States
(12) Patent Application Publication
(10) Pub. No.: US 2021/0331246 A1
(43) Pub. Date: Oct. 28, 2021

(54) REMOVING COMPONENTS OF LIQUID AGENTS IN 3D PRINTING

(71) Applicant: HEWLETT-PACKARD DEVELOPMENT COMPANY, L.P., Spring, TX (US)

(72) Inventors: Jason Hower, Corvallis, OR (US); Michael G. Monroe, Corvallis, OR (US); James E Fischer, Corvallis, OR (US); Andrew L Van Brocklin, Corvallis, OR (US); Ravi Prasad, Corvallis, OR (US)

(21) Appl. No.: 16/607,894

(22) PCT Filed: Jun. 5, 2018
(86) PCT No.: PCT/US2018/036160

§ 371 Date: Oct. 24, 2019

(51) Int. Cl. B22F 10/50; B22F 10/14; B22F 12/30; B22F 12/17; B29C 64/165; B29C 64/245; B29C 64/295; B33Y 10/00; B33Y 30/00

(52) U.S. Cl. CPC B22F 10/50; B22F 10/14; B22F 12/30; B22F 12/17; B22F 2201/20; B29C 64/245; B29C 64/295; B33Y 10/00; B33Y 30/00; B29C 64/165

(57) ABSTRACT

In an example implementation, a 3D printing system to remove components of a liquid agent includes a permeable surface. Build material formed on the permeable surface can be heated to generate vapor from a component of the liquid agent. The vapor can be drawn out of the build material through the permeable surface.

### BACKGROUND

Additive manufacturing processes can produce three-dimensional (3D) objects by providing a layer-by-layer accumulation and solidification of build material patterned from digital 3D object models. In some examples, inkjet printheads can selectively print (i.e., deposit) liquid functional agents such as fusing agents or liquid binding agents onto layers of build material within predefined areas that are to become layers of a part. The liquid agents can facilitate the solidification of the build material within the printed areas. For example, in some binder jetting processes heat can be applied during printing to at least partially cure each part layer where liquid binding agent has been applied, followed by a cure of the whole part after printing is completed.

### BRIEF DESCRIPTION OF THE DRAWINGS

Examples will now be described with reference to the accompanying drawings, in which:

FIG. 1 shows a block diagram of an example 3D printing system suitable for evolving and removing components of liquid functional agents from build materials in a 3D printing process;

FIG. 2a shows an example of a build box in an example 3D printing system in which a completed build volume with 3D parts has been formed and is undergoing one example of a “passive” binder curing and solvent evolution operation;

FIG. 2b shows an example of the build box of FIG. 2a, where powder spheres representing powdered build material are moved to the background in order to improve clarity;

FIG. 3a shows an example of a build box with a permeable build platform and an active vapor exhaust system in an example 3D printing system in which a completed build volume with 3D parts has been formed and is undergoing an example of an “active” binder curing and solvent evolution operation;

FIG. 3b shows an example of a build box in a 3D printing system comprising permeable side walls, a permeable build platform, and an active vapor exhaust system in which a completed build volume with 3D parts has been formed and is undergoing an example of an “active” binder curing and solvent evolution operation;

FIG. 4 shows another example build box in a 3D printing system that comprises permeable side walls, a permeable build platform, and an active vapor exhaust system;

FIG. 5a shows an example of a permeable side wall or platform formed as a screen or mesh;

FIG. 5b shows an example of a permeable side wall or platform formed as a metal plate with drilled holes;

FIG. 6a shows an example of pores in a micro-structure membrane formed with straight inner surfaces that diverge away from one another as they get farther away from the membrane surface;

FIG. 6b shows an alternate example of a micro-structured porous membrane where pores comprise stair-stepped inner surfaces that diverge away from one another as they get farther away from the membrane surface; and,

FIGS. 7a, 7b, and 8, show flow diagrams of example methods of removing components of a liquid agent in a 3D printing system.

Throughout the drawings, identical reference numbers designate similar, but not necessarily identical, elements.

### DETAILED DESCRIPTION

In some additive manufacturing processes, including some 3D printing processes, 3D objects or parts can be formed on a layer-by-layer basis where processed portions of each layer can be combined with processed portions of a subsequent layer until a 3D object is fully formed. Throughout this description, the terms ‘part’ and ‘object’ and their variants may be used interchangeably. In addition, while a binder jetting 3D printing process is generally used throughout this description as an example process, various aspects may apply similarly to other powder bed-based processes in which liquid functional agents are used to facilitate the solidification of a powdered build material. Furthermore, while build material is generally referred to herein as being powdered build material, such as a powdered metal material, there is no intent to limit the form or type of build material that may be used when producing a 3D object from a 3D digital object model. Various forms and types of build materials may be appropriate and are contemplated herein. Examples of different forms and types of build materials can include, but are not limited to, short fibers that have been cut into short lengths or otherwise formed from long strands or threads of material, and various powder and powder-like materials including plastics, ceramics, metals, and the like.

In various 3D printing processes, layers of a 3D part being produced can be patterned from 2D slices of a digital 3D object model, where each 2D slice defines portions of a powder layer that are to form a layer of the 3D part. Information in a 3D object model, such as geometric information that describes the shape of the 3D model, can be stored as plain text or binary data in various 3D file formats, such as STL, VRML, OBJ, FBX, COLLADA, 3MF, and so on. Some 3D file formats can store additional information about 3D object models, such as information indicating colors, textures and/or surface finishes, material types, and mechanical properties and tolerances, as well as the orientation and positioning that a 3D part will have as it is being formed within a build area of a 3D printing system during printing.

The information in a 3D object model can define solid portions of a 3D part to be printed or produced. To produce a 3D part from a 3D object model, the 3D model information can be processed to provide 2D planes or slices of the 3D model. In different examples, 3D printers can receive and process 3D object models into 2D slices, or they can receive 2D slices that have already been processed from 3D object models. Each 2D slice generally comprises an image and/or data that can define an area or areas of a layer of build material (e.g., powder) as being solid part areas where the powder is to be solidified during a 3D printing process. Thus, a 2D slice of a 3D object model can define areas of a powder layer that are to receive (i.e., be printed with) a liquid functional agent such as a binder liquid or a liquid fusing agent. According to one example, a suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc. Conversely, areas of a powder layer that are not defined as part areas by a 2D slice, comprise non-part areas where the powder is not to be solidified. Non-part areas may receive no liquid functional agent, or depending on the particular 3D printing process, they may receive a detailing agent that can be selectively applied around part contours, for example, to cool the surrounding build material and keep it from fusing or otherwise solidifying. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

In some powder-based, binder jetting 3D printing systems, layers of powdered build material, such as metal powder, can be spread over a platform or print bed within a build area or build volume. A liquid functional agent, provided as a binder liquid, can be selectively printed onto each build material layer by jetting the binder liquid onto areas where the particles of powdered build material are to be solidified to form a layer of a part, as defined by each 2D slice of a 3D object model. In some examples, heat can be applied to each build material layer in an initial heating process to evaporate water and other components of the binder liquid, such as low boiling point solvents. Additional build material layers can be printed and processed in this way until the shape of a 3D part has been defined within a build material volume.

After the 3D part is printed and defined within a build volume, a binder cure process can be performed by heating or “baking” the build volume in a subsequent heating process. The binder cure process can remove anti-coalescing solvent from small binder particles (e.g., latex particles) that are present within the binder liquid and cause the particles to soften substantially and coalesce or bind together, forming a film. The binder film can hold the powdered build material particles together and provide mechanical strength that maintains the shape of the 3D part within the build volume. The mechanically strengthened 3D part can then be excavated and removed from the build volume in preparation for subsequent processing operations. Subsequent processing can include, for example, removing excess powder from the 3D part and sintering the 3D part in a sintering oven to burn out the binder film and to further increase the strength of the part.

In some examples, the binder cure process in which small binder particles are softened and coalesce to form a binder film, can be a lengthy process. In some examples, it can take multiple hours to complete the binder cure process. One reason for this is that solvents present within the binder liquid need to be removed (i.e., heated and evaporated) before the 3D green part can be strong enough to be excavated from the build volume. However, because the build volume is formed within a build box comprising a bottom build platform and surrounding side walls, the evaporation or “evolution” of solvent vapors out of the build volume is limited to occurring through the top surface of the build volume. Other surfaces of the build volume, such as its side surfaces and its bottom surface, are not vapor-permeable due to the surrounding side walls and bottom build platform of the build box. Therefore, the removal of solvent vapors is limited to evaporation or vapor evolution through the top surface area of the build volume, which can cause the binder curing process to be lengthy.

Solvents are components of the binder liquid that facilitate jetting the binder liquid through inkjet printheads as well as facilitating coalescing of the small binder particles and formation of the binder film during the binder cure process. If the solvents do not adequately evaporate out of the build volume during the binder cure process, excavation and removal of the 3D part from the build volume can become more difficult. For example, unpatterned (i.e., unprinted) powder material can be difficult to differentiate from patterned (i.e., printed) powder material because solvents tend to migrate out of the 3D part shape where they have been initially printed, and they can pass into adjacent unprinted powder material. This can cause powder material to cling to areas of the part, and/or it can cause powder material to be removed from areas of the part where powder material is supposed to remain in order to maintain the proper shape of the part.

Accordingly example systems and methods described herein enable a faster, more efficient way of evaporating and removing components of liquid functional agents from build materials in a 3D printing process. In a binder jetting 3D printing process, for example, different components of a binder liquid can be removed from build material layers and build material volumes that are formed within a 3D build box. Example systems can include a build box having at least one of, a permeable side wall, and a permeable bottom build platform, to enable evaporation and vapor flow out of and away from all of the surface areas of the build volume instead of just the top surface area of the build volume. The system can include heating elements disposed within the permeable side walls and build platform of the build box that improve evaporation of water, solvents, and other components of a binder liquid or other liquid agent. In an initial heating operation, the heating elements can provide heating of each build material layer during the printing process to evaporate most of the water from a binder liquid, for example. In a subsequent heating operation, the heating elements enable increased heating of the finished build volume during a ‘binder curing and solvent removal process’. This process softens and coalesces small binder particles such as small latex binder particles from a binder liquid to form a binder film that can bind together powder build material particles that form the shape of a 3D part. This process also vaporizes remaining water and solvent components of the binder liquid. The system can include a vacuum system to apply negative pressure to one or multiple of: the permeable side wall(s); and build platform of the build box. The vacuum system can generate an active air flow that draws air into the top surface and/or other surfaces of the build volume, while pulling solvent and/or water vapor out of the build volume through the permeable build platform and side walls. The system can include a liquid trap catch to catch liquid solvent and/or liquid water that condenses when the vapor encounters walls of the vacuum system.

In a particular example, a 3D printing system to remove components of a liquid agent includes a build box with a permeable surface. In different examples, the permeable surface can be different surfaces of the build box, such as a side wall surface or a bottom platform surface. The system can include a material dispenser to form a build volume of build material in the build box, and a liquid dispenser to deposit binder liquid onto layers of the build material to define a 3D part within the build volume. The system includes a thermal energy source to heat build material and generate vapor from a component of the binder liquid. In different examples, the vapor can comprise water vapor and/or solvent vapor. The system also includes a vapor exhaust system to pull the vapor out of the build material and through the permeable surface of the build box.

In another example, a method of removing components of a liquid agent in a 3D printing system includes forming a build material layer on a permeable platform of a build box and depositing binder liquid onto the build material layer to define a part layer of a 3D part. In a first heating operation, the permeable platform and the build material layer can be heated to generate water vapor from the binder liquid. In some examples, solvent vapor from low boiling point solvents in the binder liquid can also be generated. The method also includes creating a negative pressure below the permeable platform to draw the vapor through holes in the permeable platform.

In another example, a 3D printing system to remove components of a liquid agent includes a build box with side walls and a permeable build platform. The build box is to receive build material layers printed with binder liquid that form a 3D part within a build volume. The system includes a thermal energy source to heat the build volume to a temperature sufficient to soften and coalesce binder particles within the binder liquid and to vaporize solvent components of the binder liquid. A vapor removal system is to pull vaporized solvent out of the build volume and through the permeable build platform.

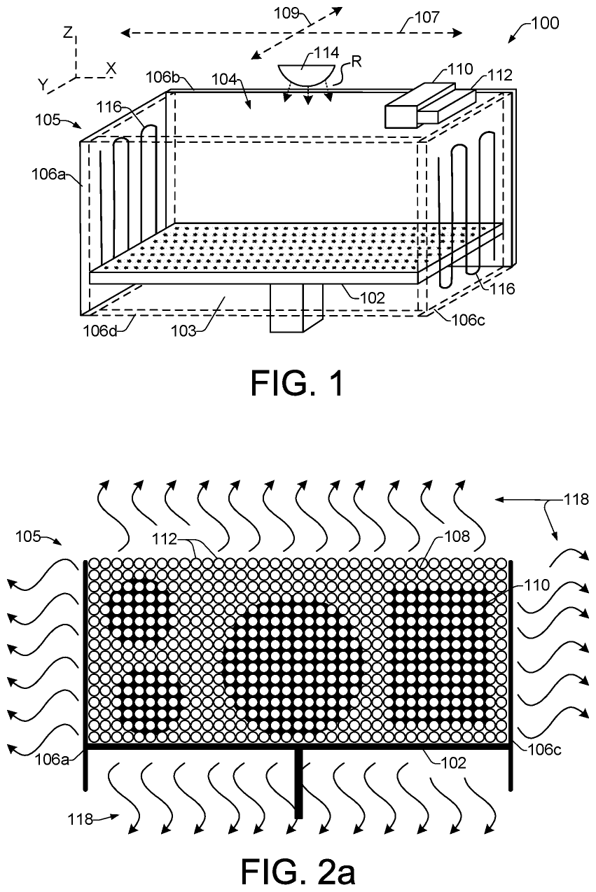

FIG. 1 shows a block diagram of an example 3D printing system 100 suitable for evolving and removing components of liquid functional agents from build materials in a 3D printing process. The example 3D printing system 100 generally comprises a binder jetting 3D printing system 100 that enables the formation and mechanical stabilization of a 3D part (sometimes referred to as a ‘3D green part’) in a layer-by-layer build process using a metal powder build material and a binder liquid, as discussed in more detail herein below. However, aspects of the example 3D printing system 100 described and illustrated herein are not limited to such a binder jetting 3D printing system, as various aspects may be similarly applicable to other systems, including other powder bed-based additive manufacturing systems in which liquid functional agents are used to facilitate the solidification of a powdered build material. Furthermore, the 3D printing system 100 depicted in FIG. 1 is shown by way of example, and it is not intended to represent a complete 3D printing system. Thus, it is understood that such an example 3D printing system 100 may comprise additional components and may perform additional functions not specifically illustrated or discussed herein.

As shown in FIG. 1, an example 3D printing system 100 includes a moveable print bed 102, or build platform 102 to serve as the floor to a work space or build area 104 in which 3D parts can be formed. The build area 104 is enclosed within a build box 105 that comprises the build platform 102 as a bottom, and vertical side walls 106 (illustrated as side walls 106a, 106b, 106c, 106d). Side walls 106a, 106c, and 106d, are shown in full or partial transparency for the purpose of illustration, in order to enable a better view of other components of the system 100. Some or all of the side walls 106 and/or the build platform 102 can comprise vapor permeable faces of the build box 105 that can be implemented, for example, as a metal screen, a metal plate with patterns of drilled holes, a micro-structured porous membrane, and so on, as discussed in more detail herein below.

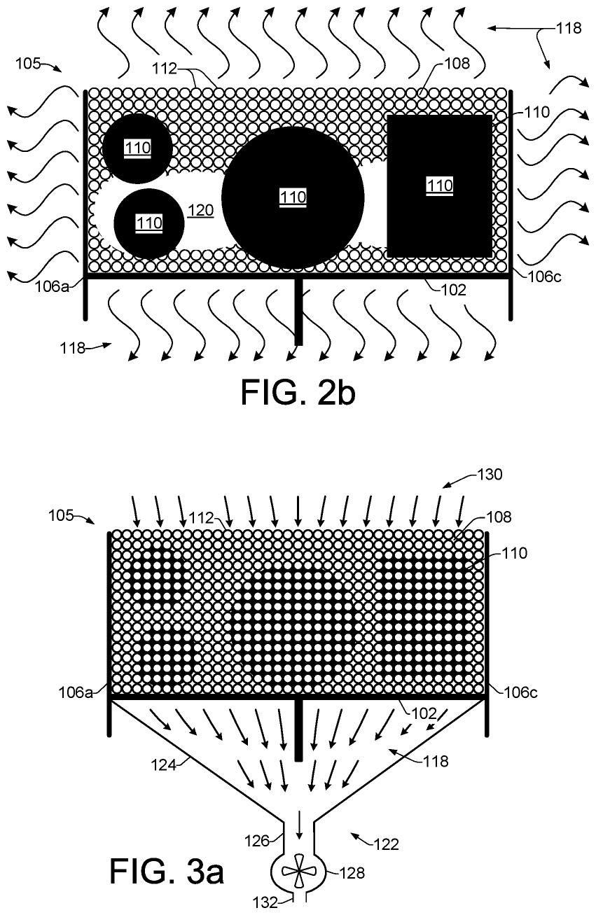

The build platform 102 can move in a vertical direction (i.e., up and down) in the z-axis. The build area 104 of a 3D printing system generally refers to a volumetric work space that develops within the build box 105 above the moveable build platform 102 as the platform moves vertically downward during the layer-by-layer printing of build material that defines the shape of each layer of a 3D part. Thus, the build box 105 initially comprises an unused area 103 underneath the build platform 102 that is defined by the build platform 102 and vertical side walls 106a, 106b, 106c, and 106d. As each layer of build material is formed and printed, the unused area 103 underneath the build platform 102 diminishes and becomes the build area 104 above the platform 102. Thus, at different times during the formation and printing of build material layers, the build box 105 comprises different volumes of unused area 103 and build area 104 that are defined by the vertical side walls 106a, 106b, 106c, and 106d, and the movable build platform 102. During the layer-by-layer process of forming and printing build material layers, the layers can be successively spread over the build platform 102 and printed on with a binder liquid to form 3D parts. As more and more build material layers are processed within the build area 104, a volume of build material (i.e., a build volume 108; FIG. 2) develops in which 3D printed parts have been formed. In some examples, a build box 105 can be an insertable and removable component of a printing system 100. Thus, a build box 105 can be inserted into a printing system 100 to facilitate the formation and printing of 3D parts within a build volume 108, and then the build box 105 can be removed from the printing system 100 to facilitate subsequent post-processing of the build volume 108.

An example 3D printing system 100 also includes a powdered build material distributor 110 that can provide a layer of build material over the build platform 102. In some binder jetting 3D printing examples, a suitable powdered build material can include a metal powder such as stainless steel 420, a powdered ceramic material, a powdered nylon such as PA12, and so on. The powder distributor 110 can include a powder supply and a powder spreading mechanism such as a roller or blade to move across the build platform 102 in the x-axis direction to spread a layer of build material.

A liquid agent dispenser 112 can deliver a liquid functional agent such as a binder liquid or a liquid fusing agent and/or detailing agent in a selective manner onto areas of a build material layer that has been spread over the build platform 102 or a previous build material layer. In some binder jetting 3D printing examples, a suitable binder liquid can comprise water, high boiling point solvents, surfactants, and small binding particles. In some examples, small binding particles can include latex binding particles on the order of 200 nanometers in diameter. A binder liquid with such a formulation can be jettable from a liquid agent dispenser 112 onto a powdered build material layer. A liquid agent dispenser 112 can include, for example, a printhead or printheads, such as thermal inkjet or piezoelectric inkjet printheads. In some examples, a printhead liquid agent dispenser 112 can comprise a platform-wide array of liquid ejectors (i.e., nozzles, not shown) that spans across the full y-axis dimension of the build platform 102. A platform-wide liquid agent dispenser can move bi-directionally (i.e., back and forth) in the x-axis as indicated by direction arrow 107 as it ejects liquid droplets onto a build material layer within the build area 104. In other examples, a printhead dispenser 112 can comprise a scanning type printhead. A scanning type printhead can span across a limited portion or swath of the build platform 102 in the y-axis dimension as it moves bi-directionally in the x-axis as indicated by direction arrow 107, while ejecting liquid droplets onto a build material layer. Upon completing each swath, a scanning type printhead can move in the y-axis direction indicated by direction arrow 109 in preparation for printing binder liquid onto another swath of the build material layer.

The example 3D printing system 100 can also include thermal energy sources such as a thermal radiation source 114, and in some examples, a resistive heating element 116. A thermal radiation source 114 can apply radiation from above the build area 104 to heat build material layers on the build platform 102. In some examples, a thermal radiation source 114 can comprise a platform-wide scanning energy source that scans across the build platform 102 bi-directionally in the x-axis, while covering the full width of the build platform 102 in the y-axis. In some examples, a thermal radiation source 114 can include a thermal radiation module comprising one or a number of thermic light lamps, such as quartz-tungsten infrared halogen lamps. In addition to a thermal radiation source 114, resistive heating elements 116 can be disposed within any one or all of the side walls 106 and the build platform 102 of the build box 105. For the purpose of illustration, resistive heating elements 116 are shown in FIG. 1 within side walls 106a and 106d. However, resistive heating elements 116 can also be disposed within side walls 106b and 106c, as well as within the build platform 102.

As noted above, a liquid agent dispenser 112 can dispense or print a binder liquid onto build material layers spread into the build area 104 of the build box 105 by a powdered build material distributor 110. As noted, the components of the binder liquid can include water, high boiling point solvents, surfactants, and small latex binding particles on the order of 200 nanometers in diameter. In general, these components of the binder liquid facilitate its jetability from the liquid agent dispenser 112, as well as facilitate the formation of a binder film that holds powdered build material particles together and provides mechanical strength to maintain the shapes of 3D parts formed within the build volume. During this process, as binder liquid is printed onto each build material layer, an initial heating operation can be applied to each build material layer that can remove much of the water component as water vapor through evaporation. In some examples, vapors from low boiling point solvents can also be removed during an initial heating operation. An initial heating operation can provide thermal energy to remove substantially all of the water from each build material layer in the form of water vapor using the radiation source 114 and resistive heating elements 116. The thermal radiation source 114 and resistive heating elements 116 can maintain the build platform 102 and each build material layer at a temperature that is conducive to evaporating substantially all of the water as each build material layer is processed. While other components of the binder liquid such as solvents can also vaporize and be removed during an initial heating operation, the temperature during the initial heating operation is generally not high enough to cause significant solvent vaporization. Rather, the temperature maintained during the initial heating operation is conducive to primarily evaporating the water component from each build material layer. Such a temperature can be, for example, a temperature on the order of 65° C.

After all the build material layers have been processed, the completed build volume 108 with the 3D printed ‘green’ parts formed therein, can undergo a second heating operation within the build box 105. The second heating operation comprises a binder curing and solvent evolution process that generates a binder film to strengthen the shapes of the 3D parts and drives off excess solvent from within the build volume. The second, binder cure, heating operation can soften and coalesce binding particles such as small latex binding particles within the binder liquid to form a binder film that provides mechanical strength to the 3D parts. Latex binding particles can comprise, for example, various polymer adhesives. During the binder curing operation, power to the thermal radiation source 114 and resistive heating elements 116 can be increased to raise the temperature of the build volume 108 (FIG. 2) to a level that raises the binding particles to a suitable temperature for curing. One example of a suitable temperature for the binder curing operation is a temperature on the order of 180° C. During the binder cure operation, the anti-coalescing solvent components of the binder liquid begin to evaporate away, which facilitates the coalescing of the latex binding particles into a viscous filmy liquid that can flow into the small capillary areas of the powdered build material. Before the viscous filmy liquid begins to cool and the anti-coalescing solvent is evaporated away, the binder forms an adhesive film that binds together the powdered build material particles in the shape of the 3D parts. After cooling, the binder film can reach a larger, target strength, which enables separation of the 3D parts from the surrounding powder that supported them. In addition, because the solvent components are no longer needed after coalescing of the latex binder particles, the binder cure operation additionally serves to drive off or evaporate the solvents from the build volume to remove them from the build box 105. The increased temperature reached in the binder curing and solvent evolution process drives solvent components out of the binder liquid solution and into a solvent vapor. While remaining water may also be vaporized and removed during the binder curing and solvent evolution process, the vapor being removed during this second heating operation is substantially solvent vapor.

FIG. 2 (illustrated as FIGS. 2a and 2b) shows an example of a build box 105 in an example 3D printing system 100 in which a completed build volume 108 with 3D parts 110 has been formed and is undergoing one example of a second heating operation comprising a “passive” binder curing and solvent evolution operation. In a passive binder curing and solvent evolution operation, the temperature of the build volume is increased as noted above to soften and coalesce the latex binding particles and to vaporize the solvent components of the binder liquid. During this operation, any remaining water component can also vaporize and be removed. In the examples shown in FIGS. 2a and 2b, the vaporized solvent 118 is then allowed to passively evolve out of the surfaces of the build volume 108 and through the permeable side walls 106 and the permeable build platform 102. Thus, the build box 105 shown in FIGS. 2a and 2b comprises permeable side walls 106 and a permeable build platform 102, and vaporized solvent 118 is shown evolving out of the surfaces of the build volume 108, and through the permeable side walls 106 and permeable build platform 102.

Referring to FIG. 2a, the many black outlined spheres 112 that make up the build volume 108 are intended to illustrate many powdered build material particles and/or groups of powdered build material particles, and they are drawn in this manner for illustrative ease. Areas of the build volume 108 showing a dark background around the particles/spheres 112 represent regions where binder liquid has been deposited to form the 3D parts 110. FIG. 2b shows the same example build box 105 as in FIG. 2a, but it illustrates the black outlined spheres 112 (i.e., representing the powdered build material) in the background in order to improve clarity. Thus, in FIG. 2b, the 3D parts 110 can be readily seen. In addition, the FIG. 2b illustration presents a clearer view of a collection of the solvent component 120 that can be gathered in the lower portion of the build volume 108. The gathered portion of solvent 120 can comprise both liquid solvent and solvent vapor that has not yet evolved from the build volume 108. The gathered solvent 120 can remain suspended above the build platform 102 due to the heat being generated within the underlying platform 102.

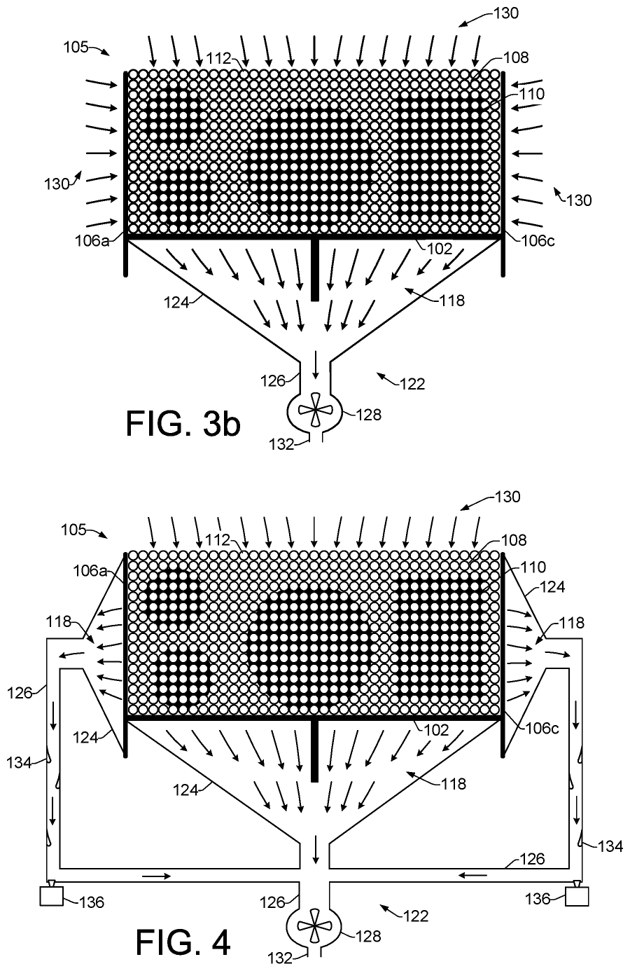

FIG. 3 (illustrated as FIGS. 3a and 3b) shows an example of a build box 105 in an example 3D printing system 100 in which a completed build volume 108 with 3D parts 110 has been formed and is undergoing different examples of a second heating operation comprising an “active” binder curing and solvent evolution operation. In an active binder curing and solvent evolution operation, the temperature of the build volume is increased as noted above to soften and coalesce the binding particles (e.g., latex binding particles, polymer adhesive particles, etc.) into a film, and to vaporize the solvent components of the binder liquid. The vaporized solvent is then actively drawn out of the build volume 108 and pulled through a permeable surface of the build box 105 by an active vapor exhaust system 122. An active vapor exhaust system 122 can include, for example, an air coupling 124 such as a box or chamber that affixes onto the back side of a permeable side wall 106 and/or the underside of the permeable build platform 102. Vapor conduits 126 can connect each air coupling 124 to a vacuum pump 128 or fan that can generate a negative pressure relative to atmospheric pressure.

Referring to FIG. 3a, an example build box 105 in a 3D printing system 100 comprises a permeable build platform 102 and an active vapor exhaust system 122. In the example build box 105 of FIG. 3a, the side walls 106 are not permeable side walls, and an air coupling 124 is affixed to the underside of the permeable build platform 102. In an example binder curing and solvent evolution operation, the thermal radiation source 114 and resistive heating elements 116 (FIG. 1) can heat the build volume 108, causing small binder particles to soften and coalesce into a film, and solvent to vaporize. The active vapor exhaust system 122 can create a negative pressure that pulls the vaporized solvent 118 through the permeable build platform 102. As shown in FIG. 3a, the negative pressure from the active vapor exhaust system 122 also pulls atmospheric air 130 through the top, open surface of the build volume 108. A negative pressure can comprise a negative pressure value low enough that the resultant air flow through the permeable build platform 102 does not cause any disruption or deformation of the 3D green parts within the build box 105. A range of negative pressures may be appropriate, such as, for example, negative pressures ranging from partial pascals to multiple pascals.

Referring to FIG. 3b, an example build box 105 in a 3D printing system 100 comprises permeable side walls 106, a permeable build platform 102, and an active vapor exhaust system 122. In the example build box 105 of FIG. 3b, the permeable side walls 106 can be open to atmospheric air, and an air coupling 124 can again be affixed to the underside of the permeable build platform 102. In an example binder curing and solvent evolution operation, the thermal radiation source 114 and resistive heating elements 116 (FIG. 1) can heat the build volume 108, causing binder particles to soften and coalesce into a film, and solvent components to vaporize. The active vapor exhaust system 122 can create a negative pressure that pulls the vaporized solvent 118 through the permeable build platform 102. As shown in FIG. 3b, the negative pressure from the active vapor exhaust system 122 can also pull atmospheric air 130 through the top, open surface of the build volume 108, as well as pulling atmospheric air 130 through each side surface of the build volume 108, via the permeable side walls 106 that are adjacent to each side surface of the build volume.

FIG. 4 shows an example build box 105 in a 3D printing system 100 that comprises permeable side walls 106, a permeable build platform 102, and an active vapor exhaust system 122. In the example build box 105 of FIG. 4, an air coupling 124 can be affixed to the back of each of the permeable side walls 106 and to the underside of the permeable build platform 102. In an example binder curing and solvent evolution operation, the thermal radiation source 114 and resistive heating elements 116 (FIG. 1) can heat the build volume 108, causing binder particles to soften and coalesce into a film, and solvent components to vaporize. The active vapor exhaust system 122 can create a negative pressure that pulls the vaporized solvent 118 through each of the permeable side walls 106 and through the permeable build platform 102. As shown in FIG. 4, the negative pressure from the active vapor exhaust system 122 also pulls atmospheric air 130 through the top, open surface of the build volume 108.

In each of the examples of FIGS. 3a, 3b, and 4, the vaporized solvent 118 and any remaining water vapor is drawn out of the build volume 108 by the active vapor exhaust system 122. These vapors can be removed from a 3D printing system 100 as vapor through a vapor port 132, and/or as condensed liquid 134, such as condensed liquid water 134 and condensed liquid solvent 134, through a liquid catch trap 136. For example, when vaporized solvent 118 is pulled into the active vapor exhaust system 122 and contacts an air coupling 124 and/or a vapor conduit 126, it can condense onto the surfaces of the coupling 124 and/or conduit 126 and drip into a liquid catch trap 136, as shown in FIG. 4.

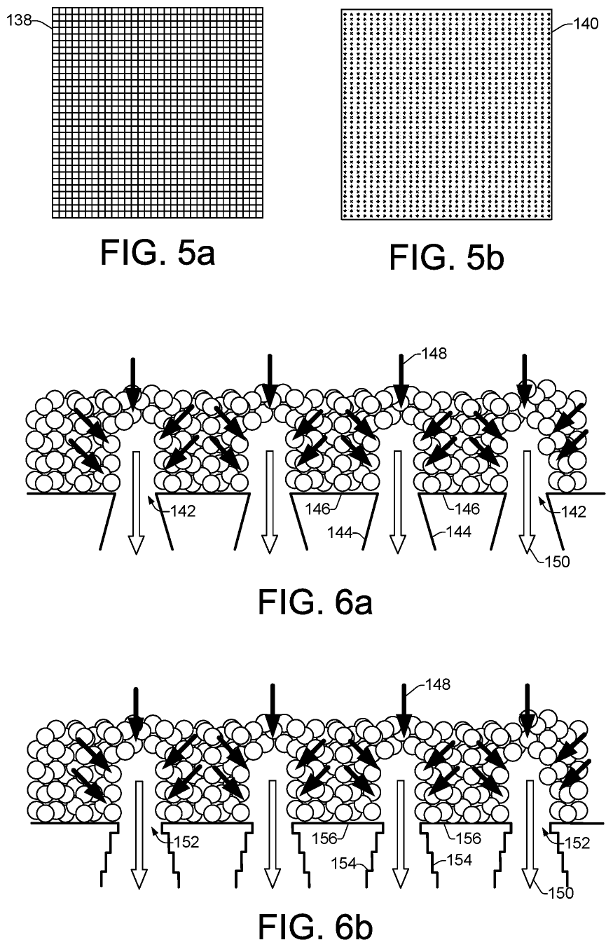

As noted above, some or all of the side walls 106 and/or the build platform 102 can comprise permeable faces of a build box 105. Each permeable side wall or platform can be formed, for example, as a metal screen, a metal plate with patterns of drilled holes, a micro-structured porous membrane, and so on. FIG. 5 (illustrated as FIGS. 5a and 5b) shows different examples of a permeable side wall or platform. FIG. 5a shows an example of a permeable side wall or platform formed as a screen 138 or mesh. FIG. 5b shows an example of a permeable side wall or platform formed as a metal plate 140 with holes. In general, a permeable side wall or platform is to provide vapor permeability while also preventing powdered build material particles from passing through. Powdered build material particles, such as powdered metal particles are of a relatively small size, and they can have a wide distribution of sizes. The size of the holes in the permeable side walls 106 and/or build platform 102 can be tailored to the build particle sizes. In some examples, the size of the holes in a permeable screen 138 or a permeable metal plate 140 can be an average of the sizes of the diameters of the particles of powdered build material being used. In some examples, such an averaged size diameter can be on the order of 15 to 20 microns in diameter. In some examples, the size of the holes in the permeable screen 138 or permeable metal plate 140 can be larger than the average size of the particles of build material. This enables some particles to fall through the hole and a stable arch shaped structure to form from powdered build material particles gathering over the pore openings as noted below with regard to FIG. 6a.

In some examples, a permeable side wall or platform formed as a micro-structured porous membrane can help prevent “plugging,” “jamming” or “crowding” of particles within the pores of the membrane, which can enhance the flow of vapors from evolving solvents and water. Pore plugging can be reduced by using micro-structured enlarging pores that open outwardly to allow stable void formations within the powder build material surrounding the pore. FIG. 6 (illustrated as FIGS. 6a and 6b) shows different examples of micro-structured porous membranes having different micro-structured enlarging pores that open outwardly. FIG. 6a shows an example of pores 142 formed with straight inner surfaces 144 that diverge away from one another as they get farther away from the membrane surface 146. The diverging inner surfaces 144 provide a pore structure with a generally outward or “opening funnel” type outlet which causes stable open structures to form over the pores. As shown in FIG. 6a, a stable arch shaped structure is formed by powdered build material particles over the pore openings. The small dark arrows 148 represent air flow encountering high resistance as it passes through the particles, while the larger clear arrows 150 represent air flow encountering low resistance as it passes into and through the stabilized pore openings 142.

FIG. 6b shows an alternate example of a micro-structured porous membrane where pores 152 comprise stair-stepped inner surfaces 154 that diverge away from one another as they get farther away from the membrane surface 156. Like the example in FIG. 6a, the diverging inner surfaces 154 provide a pore structure with a generally outward or “opening funnel” type outlet which causes stable open structures to form over the pores 152. As shown in FIG. 6b, a stable arch shaped structure is formed by powdered build material particles over the pore openings. The small dark arrows 148 represent air flow encountering high resistance as it passes through the particles, while the larger clear arrows 150 represent air flow encountering low resistance as it passes into and through the stabilized pore openings 152.

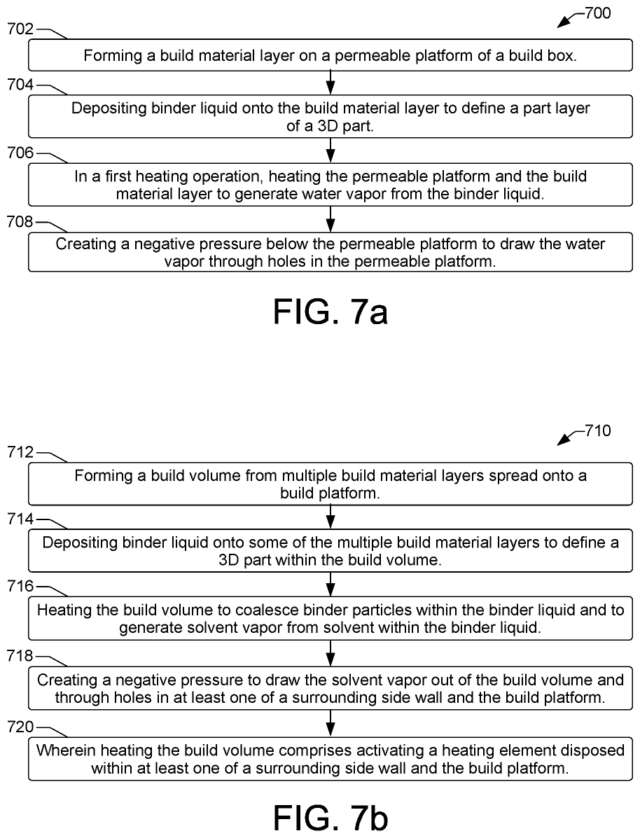

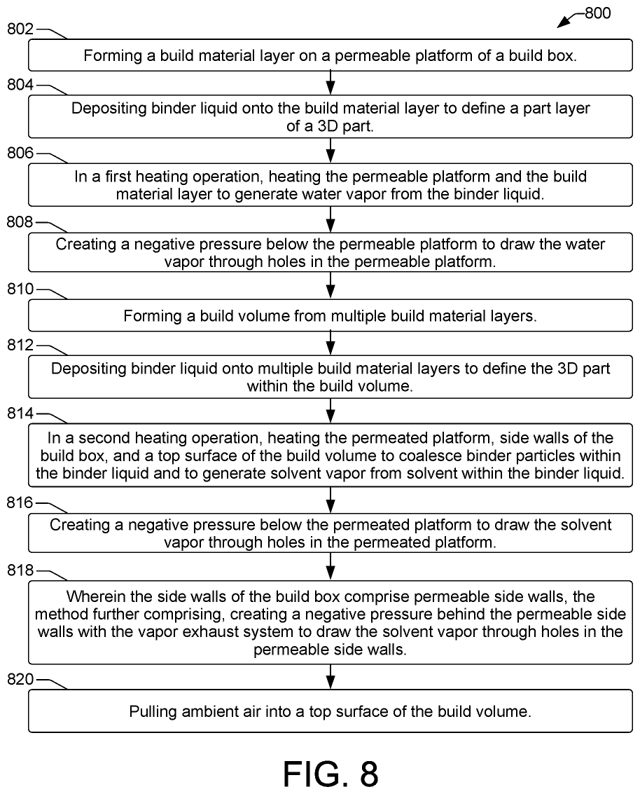

FIGS. 7a, 7b, and 8, show flow diagrams of example methods 700, 710, and 800, of removing components of a liquid agent in a 3D printing system. Method 800 comprises extensions of method 700 and incorporates additional details of method 700. Methods 700, 710, and 800, are associated with examples discussed above with regard to FIGS. 1-6, and details of the operations shown in methods 700, 710, and 800, can be found in the related discussion of such examples. The methods 700, 710, and 800, may include more than one implementation, and different implementations of methods 700, 710, and 800, may not employ every operation presented in the respective flow diagrams of FIGS. 7a, 7b, and 8. Therefore, while the operations of methods 700, 710, and 800, are presented in a particular order within their respective flow diagrams, the order of their presentations is not intended to be a limitation as to the order in which the operations may actually be implemented, or as to whether all of the operations may be implemented. For example, one implementation of method 700 might be achieved through the performance of a number of initial operations, without performing other subsequent operations, while another implementation of method 700 might be achieved through the performance of all of the operations.

Referring now to FIG. 7a, an example method 700 of removing components of a liquid agent in a 3D printing system begins at block 702 with forming a build material layer on a permeable platform of a build box. The method includes depositing binder liquid onto the build material layer to define a part layer of a 3D part, as shown at block 704. In a first heating operation, as shown at block 706, the permeable platform and the build material layer can be heated to generate vapor from the binder liquid. The vapor generated in a first heating operation comprises substantially water vapor. The vapor generated may additionally include some solvent vapor. The method can also include creating a negative pressure below the permeable platform to draw the vapor through holes in the permeable platform, as shown at block 708.

Referring now to FIG. 7b, another example method 710 of removing components of a liquid agent in a 3D printing system begins at block 712 with forming a build volume from multiple build material layers spread onto a build platform. As shown at block 714, the method can include depositing binder liquid onto some of the multiple build material layers to define a 3D part within the build volume. The method can also include heating the build volume to coalesce binder particles within the binder liquid and to generate solvent vapor from solvent within the binder liquid, as shown at block 716. As shown at block 718, a negative pressure can be created to draw the solvent vapor out of the build volume and through holes in at least one of a surrounding side wall and the build platform. In some examples each of multiple surrounding side walls can have holes through which solvent vapor can be drawn. In some examples, the build platform can have holes through which solvent vapor can be drawn. As shown in block 720, in some examples, heating the build volume includes activating a heating element disposed within at least one of a surrounding side wall and the build platform. In some examples, each of multiple surrounding side walls as well as the build platform can have heating elements that can be activated to heat the build volume.

Referring now to FIG. 8, another example method 800 of removing components of a liquid agent in a 3D printing system is shown. As noted above, method 800 comprises extensions of method 700 and incorporates additional details of method 700. Therefore, the method 800 begins with forming a build material layer on a permeable platform of a build box, as shown at block 802. The method includes depositing binder liquid onto the build material layer to define a part layer of a 3D part, as shown at block 804. In a first heating operation, as shown at block 806, the permeable platform and the build material layer can be heated to generate vapor from the binder liquid. The vapor generated in a first heating operation comprises substantially water vapor. The vapor generated may additionally include some solvent vapor. The method can also include creating a negative pressure below the permeable platform to draw the vapor through holes in the permeable platform, as shown at block 808.

Continuing at blocks 810 and 812, the method 800 includes forming a build volume from multiple build material layers, and depositing binder liquid onto multiple build material layers to define the 3D part within the build volume. As shown at block 814, the method 800 can include, in a second heating operation, heating the permeable platform, side walls of the build box, and a top surface of the build volume to melt binder particles within the binder liquid and to generate vapor from solvent and/or water from the binder liquid. Vapor generated in the second heating operation comprises substantially, solvent vapor from solvent within the binder liquid. As shown at block 816, the method can also include creating a negative pressure below the permeated platform to draw the vapor through holes in the permeated platform. In some examples, as shown at block 818, the side walls of the build box can comprise permeable side walls, and the method can further include further creating a negative pressure behind the permeable side walls with the vapor exhaust system to draw the vapor through holes in the permeable side walls. As shown at block 820, the method also includes pulling ambient air into a top surface of the build volume.

What is claimed is:

1. A 3D printing system to remove components of a liquid agent comprising:
an insertable build box comprising a permeable surface;
a material dispenser to form a build volume of build material in the build box;
a liquid dispenser to deposit binder liquid onto layers of the build material to define a 3D part within the build volume;
a thermal energy source to heat build material, generating vapor from a component of the binder liquid; and,
a vapor exhaust system to pull the vapor out of the build material and through the permeable surface of the build box.

2. A system as in claim 1, wherein the vapor exhaust system comprises:
an air coupling to couple to a backside of the permeable surface of the build box; and,
a vacuum pump to generate a negative pressure in the air coupling to pull the vapor through the permeable surface of the build box.

3. A system as in claim 2, further comprising:
a vapor conduit to connect the air coupling with the vacuum pump; and,
a liquid catch trap to receive liquid that condenses on a surface of the vapor conduit from the vapor.

4. A system as in claim 1, wherein the permeable surface comprises a permeable build platform of the build box.

5. A system as in claim 1, wherein:
the permeable surface comprises multiple permeable surfaces including a permeable build platform and permeable side walls; and,
the vapor exhaust system is coupled to each of the multiple permeable surfaces to pull the vapor out of the build material and through the multiple permeable surfaces.

6. A system as in claim 1, wherein the permeable surface comprises a surface selected from a screen surface, a metal plate surface having drilled holes, and a micro-structured porous membrane.

7. A system as in claim 1, wherein the permeable surface comprises holes having a size that is larger than an average of the size of particles of the build material.

8. A system as in claim 1, wherein the permeable surface comprises a micro-structured porous membrane, the membrane comprising:
outwardly opening pores, the outwardly opening pores comprising inner walls that diverge away from one another as they move away from pore openings.

9. A method of removing components of a liquid agent in a 3D printing system, comprising:
forming a build material layer on a permeable platform of a build box;
depositing binder liquid onto the build material layer to define a part layer of a 3D part;
in a first heating operation, heating the permeable platform and the build material layer to generate water vapor from the binder liquid; and,
creating a negative pressure below the permeable platform to draw the water vapor through holes in the permeable platform.

10. A method as in claim 9, further comprising:
forming a build volume from multiple build material layers;
depositing binder liquid onto multiple build material layers to define the 3D part within the build volume;
in a second heating operation, heating the permeable platform, side walls of the build box, and a top surface of the build volume to coalesce binder particles within the binder liquid and to generate solvent vapor from the binder liquid; and,
creating a negative pressure below the permeable platform to draw the solvent vapor through holes in the permeable platform.

11. A method as in claim 10, wherein the side walls of the build box comprise permeable side walls, the method further comprising:
creating a negative pressure behind the permeable side walls with the vapor exhaust system to draw the solvent vapor through holes in the permeable side walls.

12. A method as in claim 11, further comprising pulling ambient air into a top surface of the build volume a top surface of the build volume.

13. A 3D printing system to remove components of a liquid agent comprising:
a permeable build platform to receive build material layers printed with binder liquid to form a 3D part within a build volume;
a thermal energy source to heat the build volume to a temperature sufficient to soften and coalesce binder particles of the binder liquid into a film, and to vaporize solvent components of the binder liquid; and,
a vapor removal system to pull vaporized solvent out of the build volume and through the permeable build platform.

14. A system as in claim 13, wherein the thermal energy source comprises:
a radiant heat source disposed over the build volume to heat a top surface of the build volume; and,
a resistive heating element disposed within the permeable build platform and within each of multiple side walls to heat the build volume from a bottom surface and side surfaces, respectively.

15. A system as in claim 13, wherein the vapor removal system comprises:
a vapor port to exhaust vaporized solvent from the 3D printing system; and,
a solvent trap to receive liquid solvent that condenses on surfaces of the vapor removal system.
